(19) United States
(12) Patent Application Publication
(10) Pub. No.: US 2007/0027889 A1
(43) Pub. Date: Feb. 1, 2007

(54) System and method for facilitating a guided assembly of people

(76) Inventor: Jason Kaufman, New York, NY (US)

Correspondence Address: KENYON & KENYON LLP, ONE BROADWAY, NEW YORK, NY, 10004, US

(21) Appl. No.: 11/192,673

(22) Filed: Jul. 29, 2005

(51) Int. Cl. G06F 7/00

(52) U.S. Cl. 707/101

(57) ABSTRACT

In a system and method for facilitating an assembly of users with commonalities, a processor may determine which users have commonalities, may determine a location at which to assemble, and may invite each of the determined users an invitation to assemble at the determined location.

### BACKGROUND

People often seek to meet with those who have interests or goals common to their own. Such people often assemble, e.g., to take advantage of their combined talents and abilities, for using their combined efforts towards a common goal, for entertainment, for developing personal interrelationships that aid in their commercial and/or personal growth, for dating, etc. There is a vast multitude of people with whom a person comes into contact throughout the person's life, and even in a single day. It may be desirable for the person to meet people in a guided manner, such that helps the person meet those people with whom the person can interrelate to advance the person's goals and/or interests. For example, it may be desirable for the person to be guided to meet people who share goals and/or interests common to the person, that have talents and abilities that complement those of the person, that have particular characteristics or attributes that the person often finds attractive, etc.

It is conventional to use computers and other electronic devices that aid in narrowing the playing field so that the person is directed to those people with whom meeting is more likely to result in a desired collaboration. For example, chat rooms are maintained in cyberspace. The chat rooms are named, for example, according to a topic of interest. People interested in the topic join the chat room and thereby “meet” in cyberspace other people who share an interest in the same topic. The probability of a person meeting another with whom the person shares an interest is thereby increased.

Based on cyberspace discussions with others, the person can decide whether to meet any of those others in person, and, if so, with whom. Often, however, discussions in cyberspace are misleading. After meeting in person with someone who seemed to be of interest in view of cyberspace discussions, the person may determine the meeting to have been futile and may therefore choose to begin the process again, i.e., “enter” a cyberspace area in hope of finding someone with whom it is advantageous to meet. This process may be repeated numerous times until the person finally meets the right other person, if ever. Because of the misleading nature of discussions in cyberspace, the person often arranges to meet with the wrong people and neglects to meet with the right people, mistakenly determining from the cyberspace discussions that the latter are not of interest.

Furthermore, conventional systems provide cyberspace areas referenced by a particular topic, interest, or characteristic. People are attracted to a particular cyberspace area according to the particular topic, interest, or characteristic by which the area is referenced. However, while people might not share one particular interest, they may share another. Therefore, it often occurs that two or more people for whom it would be advantageous to meet do not meet since they search for people in certain cyberspace areas that relate to the particular attributes not shared by the people. Consequently, they are not made aware of their commonalities.

Accordingly, it may be desirable to more accurately guide a person to meet people who would benefit the person and to increase the probability of meeting such people.

### BRIEF DESCRIPTION OF THE DRAWINGS

FIG. 1 is a block diagram that illustrates components of an example system, according to an example embodiment of the present invention.

FIG. 2 is a flowchart that illustrates an example procedure which may be executed to determine an optimal meeting location, according to an example embodiment of the present invention.

FIG. 3 is diagram that illustrates a game implemented according to an example embodiment of the present invention.

### DETAILED DESCRIPTION

Since cyberspace meetings are often misleading, it may be desirable to organize a guided real space assembly of people. Embodiments of the present invention relate to a system and method for organizing an assembly of people in a real space environment, and more particularly, for doing so in a guided manner, such that the likelihood of a person in the assembly will meet another with a common interest or goal, or who would promote the person's business or personal growth, may be greater than would otherwise be in a non-guided assembly. Embodiments of the present invention further relate to a system and method for guiding assembled people to discover their commonalities, particularly by increasing interaction between the assembled people and directing their interactions to focus on their commonalities.

In an embodiment of the present invention, for a plurality of people, a processor may determine a group from the plurality of people that share one or more commonalities. In an embodiment of the present invention, the processor may choose from a plurality of real space locations a particular location as a meeting place. The processor may transmit to each member of the determined group an invitation to meet at the location. In an embodiment of the present invention, the processor may transmit to the members information regarding other members and/or suggested topics of conversation. In an embodiment of the present invention, the processor may facilitate the implementation of a real space meeting game.

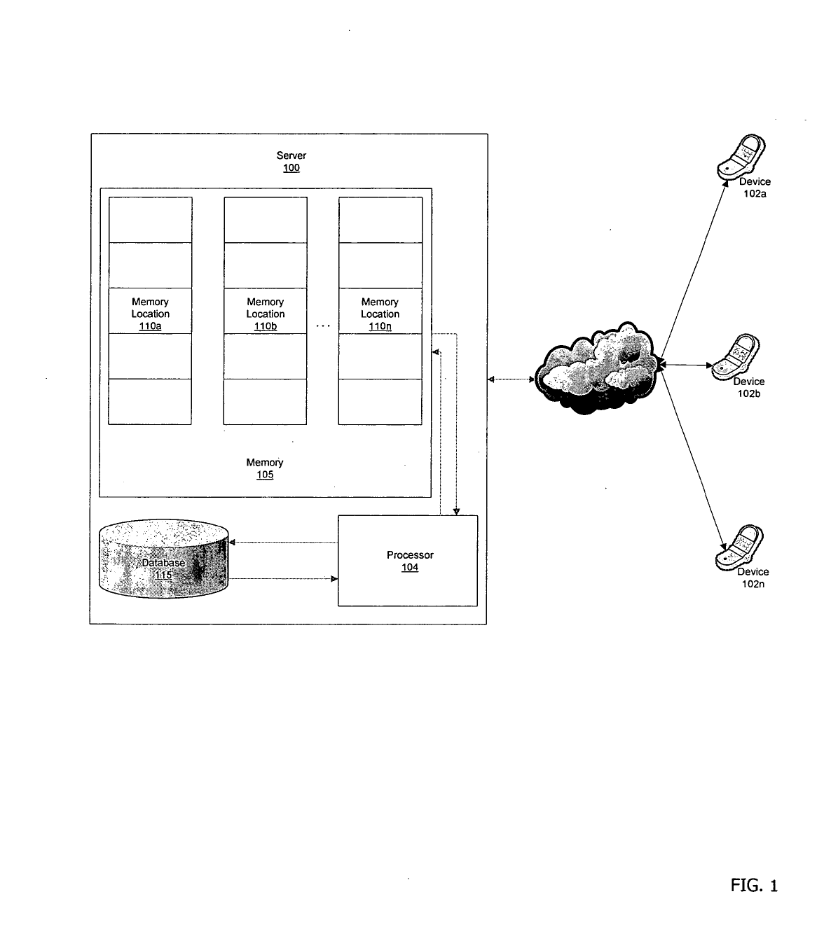

FIG. 1 illustrates an example system according to an example embodiment of the present invention. The system may include a processor 104 at a server 100. Members of the system may each access the server 100 via devices 102a-n. For example the devices 102 may be computers, telephones, pagers, computer terminals or any other conventional data transmitter and/or receiver device. The processor 104 may transmit messages towards the devices 102. System users may transmit messages to the server 100.

In an embodiment of the present invention, a memory 105 may be provided at the server 100. The memory 105 may include, e.g., a plurality of member-assigned memory locations 110a-n. Instead of, or in addition to, transmitting messages to the devices 102, the server 100 may store messages and/or other data for each member at the member's corresponding member-assigned memory location 110. To view the messages or data, the members may access the memory locations 110.

For example, the server 100 may provide a web page for display at a device 102. A member may enter at the device 102 a Uniform Resource Locator (URL) that addresses the server 100 or select a link that addresses the server 100. In response, a data request may be transmitted to the server 100. In response to the request, the server 100 may transmit data to the requesting device 102. For example, the data may be for providing a sign-in page. A web browser application at the device 102 may arrange the returned data for display in a web page at the device 102. The member may sign into the system, e.g., by entering a username and password. In one embodiment, the server 100 may subsequently transmit to the device 102 a new page customized for the member, e.g., according to user settings. The web page may include links via which the member may request particular data. For example, the page may include a link to a memory location 110 that corresponds to the member.

In an embodiment of the present invention, a database 115, e.g., a relational database, may be provided at the server 100. The processor 104 may store in the database 115 information regarding the system member and regarding real space locations, e.g., restaurants, theatres, parks, etc. For example, the server 100 may provide a registration page via which a person may sign up as a system member. The registration page may include a plurality of data entry fields for providing information regarding the person's interests, likes, dislikes, physical characteristics, such as age and/or gender, etc. During registration or post-registration, the user may post messages regarding activities performed, events experienced, observations, comments regarding places visited, comments about people met, and/or other comments and messages.

In an embodiment of the present invention, the processor 104 may provide the information entered by members and/or by others in a manner such that the information may be sorted and accessed according to various criteria. Some exemplary non-exclusive ways in which the data may be sorted or presented may be by location, by user, by particular characteristics, by ratings, or by topic. The data may be sorted by main categories and by sub-categories. For example, the processor 104 may sort the data by location, and the locations may be sorted by user ratings. For example, users may rate locations, e.g., on a scale of 1-10, bad to excellent, or according to any other conventional ratings system. The locations may be further sorted by region, country, state, and/or city.

In an embodiment of the present invention, from comments, messages, and/or indicated personal features entered by a plurality of members, the processor 104 may determine commonalities shared by some of the system members. Based on the commonalities and/or based on other member characteristics, the processor 104 may determine that a meeting between two or more of the members is likely to benefit the members. For example, the processor 104 may determine from the data in the database 115 that a first member is a single male located in New York City, is a ball player, and seeks to meet a single female who is a musician. The processor 104 may further determine that a second member is a single female located in New York City, is a musician, and seeks to meet a single male who is a ball player. The processor 104 may accordingly determine that a meeting between the first and second members is likely to be of benefit to the first and second members.

In an embodiment of the present invention, the processor 104 may invite members to a meeting. For example, the processor 104 may transmit to the members a message that includes an invitation to meet at a particular location. In one embodiment, the location may be chosen by the processor 104. Alternatively, one or more of the members may choose the location. Alternatively, a location may be chosen by a combination of the members and the processor 104. For example, the members may indicate to the processor 104 a desired meeting location. The processor 104 may then choose a particular location in accordance with the location preferences indicated by the members.

In one embodiment, the processor 104 may store the invitation message in each of the members corresponding member-assigned memory locations 110. Alternatively, or in addition, the processor 104 may transmit the message to each member's phone 102 or other device 102, e.g., as a Short Message Service (SMS) or Multimedia Messaging Service (MMS) text message, or as a message sent via a Flash based program, via a lava based program, or via any other conventional data transmission platform. In one embodiment, the processor 104 may provide the message in different ways depending on a preference indicated by the members. For example, one member may prefer to receive the message at a corresponding memory location 110, another member may prefer to receive the message at a particular e-mail provider, and still another member may prefer to receive the message at a cell phone 102. For example, each user may register with the system one or more devices 102 via which to receive messages.

In an embodiment of the present invention, the processor 104 may choose the particular members to whom to send the meeting invitation. For example, the processor 104 may determine that a meeting between two or more of the members is likely to benefit the members, as discussed above. The processor 104 may accordingly transmit the invitation to said two or more members. In one embodiment, the processor 104 may transmit the invitation to one or more members in response to a request by a person, e.g., a member, to set up a meeting. For example, the requesting member may submit a general request for the processor 104 to arrange a meeting that is likely to benefit the requesting member; may request a meeting for a particular purpose, such as for a date, for participating in an activity or event, for collaborating to achieve a particular goal, etc.; and/or may request a meeting with one or more other particular members or with members to be selected by the processor 104 from a particular group of members indicated by the requesting member. In response to the request, the processor 104 may determine which other members, if any, to invite to the meeting.

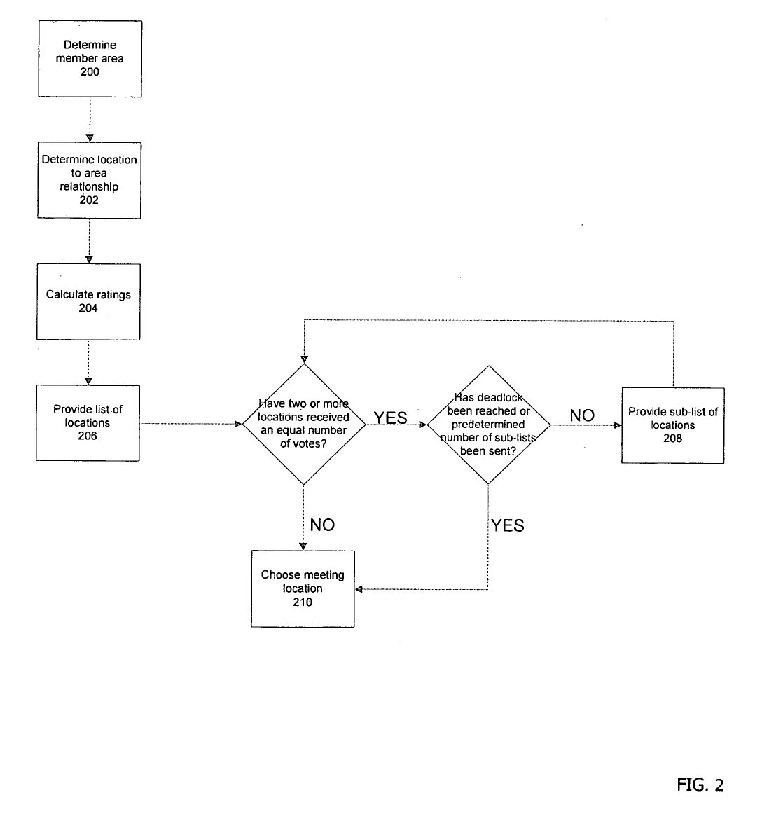

In an embodiment of the present invention, the processor 104 may choose the location to which the processor 104 may invite the members and/or other persons. FIG. 2 illustrates an example procedure which may be executed by the processor 104 for choosing a meeting location. For example, in 200, based on data in the database 115, the processor 104 may determine a geographic member area in which all invited members are located. In 202, the processor 104 may determine how the locations relate to the member area. For example, the processor 104 may determine which locations are located in the member area, are within a predetermined radius from the center of the member area, and/or are the closest to member area. The processor 104 may limit the locations which may be chosen to only those locations that within a predetermined area, e.g., within the predetermined radius from the center of the member area. Alternatively, the processor 104 may factor in the distance of each location in determining a rating assigned to each location. In 204, the processor 104 may calculate a rating for each of the locations. The processor 104 may consider numerous factors in assigning a rating to the locations. The following is a non-exhaustive list of factors that may be considered. The factors may include user-indicated ratings and comments, geographic coordinates of the locations, frequency at which members visit a particular location, an indication by the invited members of a desire for one or more particular locations to be chosen as the meeting location, whether or not the location is particularly conducive for the purpose of the meeting, and/or the last time the members visited the location. For example, if it is known that a member equally enjoys visiting two of the locations, but within the previous two weeks has visited one of the locations 5 times and the other location only once, it may be desirable to choose the second location as the current meeting location. For the ratings calculation, each of the factors may be weighted differently, so that one factor may influence the rating to a greater degree than another factor. For example, each factor may be assigned a number based on the data in the database 115. The number may be multiplied by a weighting factor. The processor 104 may input the resultant values in an equation for producing an overall rating.

In one embodiment, after 204, the processor 104 may proceed to 210, omitting performance of steps 206-208. In 210, the processor 104 may choose as the meeting location, the location for which the processor 104 calculates the highest rating. Alternatively, in 206, the processor 104 may provide the requesting member or all of the invitees with a list of a predetermined number ‘n’ of locations. For example, the list may include the ‘n’ highest rated locations. In response, the invitees may transmit to the server 100 a desired one of the listed locations. In 210, the processor 104 may choose as the meeting location, the location receiving the most votes. If two or more locations receive an equal number of votes, the processor 104 may proceed directly to 210 to choose the location for which the processor 104 calculated the highest rating. Alternatively, in 208, the processor 104 may transmit a new list to the invitees including the locations that received the equal number of votes. In one embodiment, transmittal of sub-lists may be repeated until a deadlock occurs, at which point the processor 104 may, in 210, choose the location for which the highest rating was calculated. Alternatively, or in addition, the system may provide that after a predetermined number of sub-list transmissions, the processor 104 may proceed to 210 to choose from the remaining locations the location for which the processor 104 calculated the highest rating.

It may occur that one or more of the members refrain from choosing a location after receiving a location list. In an embodiment of the present invention, the processor 104 may wait a predetermined amount of time before proceeding to 210 to allow for the members to submit a location choice. After passage of the predetermined amount of time, the processor 104 may proceed to 210 even if no choices have been submitted.

In an embodiment of the present invention, in response to a meeting invitation received from the processor 104, an invitee may transmit to the server 100 an acceptance message or a rejection message. After transmitting the invitation messages, the processor 104 may wait a predetermined amount of time for a response. If a response is not received from an invitee, the processor 104 may treat the lack of a response as a rejection. After receiving all responses, or after passage of the predetermined amount of time, the processor 104 may transmit to each of the accepting members a message indicating the number of accepting members and/or an identification of the accepting members. In one embodiment, the processor 104 may wait a second predetermined amount of time during which an accepting member may indicate a wish to back out of the meeting, e.g., because too few members accepted the invitation. After passage of the second predetermined amount of time, the processor 104 may transmit a final confirmation message. In one embodiment, the processor 104 may transmit a message indicating the cancellation of the meeting if fewer than a predetermined number of invitees transmitted an acceptance message.

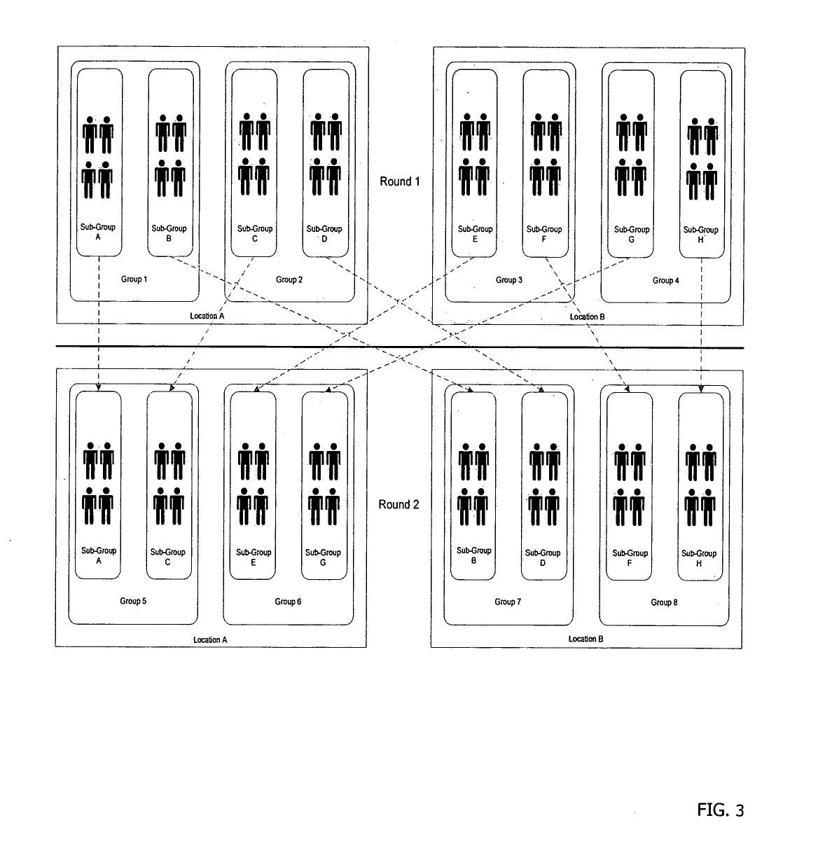

FIG. 3 illustrates a non-limiting example of a game, e.g., a dating game, that may be implemented according to an embodiment of the present invention. At a predetermined time, in response to a member request, or in response to another triggering event, the processor 104 may invite a plurality of members to join in a dating game. The requesting member may provide the processor 104 with a list of one or more people, e.g., system members, to be invited to join the dating game. The processor 104 may provide for a game to be commenced upon a condition that a predetermined number of people join the game and that a predetermined number of groups may be formed. For example, commencement of the game may be conditioned upon the joining of four groups, each group including eight people. Commencement of the game may be further conditioned upon the inclusion in each group of an equal number of males and females.

If a requesting member does not identify all seven required members (aside from the requesting member) to be invited, if some of the seven members reject the invitation, or if inviting the identified members violates a game rule, e.g., when all invitees form a single group and are of the same gender, the processor 104 may choose additional members to invite to the game. The way in which the processor 104 may choose the additional members is discussed above. In determining the members to be invited, the processor 104 may consider for example gender, race, religion, ethnicity, and preferences of players who have already joined the game. The processor 104 may repeatedly invite members until the game is terminated or until all eight members have agreed to join the game. The game may be terminated, e.g., after passage of a predetermined amount of time from the time of the member request or from the time of transmission of the first invitation. Alternatively, the game may be terminated after the processor 104 receives a predetermined number of rejections. In one embodiment, the processor 104 may repeatedly invite members until all eight members have agreed to join the game, unless the game is terminated. If after passage of the predetermined amount of time, acceptance messages are still not received from the number of players required to play the game, the game may be terminated. The processor 104 may transmit a message to the invited players notifying them of the game's termination.

The players may be divided into groups that the processor 104 determines are most likely to benefit the players. A way in which such a determination may be made is discussed above. The processor 104 may transmit to each of the players a message that identifies a real space location at which to meet the other players. For example, for round one of the game, the processor 104 may direct two groups to location A and another two groups to location B. The processor 104 may transmit to each player a message that provides a way for the players to recognize their co-players. For example, the processor 104 may provide each player of group 1 with physical features of one or more of the other players of group 1, such that all the players of group 1 may ultimately find each other. Alternatively, the processor 104 may transmit a message to one or more players instructing the player to perform a particular act. For example, the processor 104 may transmit the same instruction to all players of group 1 and a different instruction to all players of group 2. Other methods of identification may be provided, but further discussion regarding the ways in which players may identify each other is not required for an understanding of the present invention.

Each group of players may thereby separately meet to interact with one another. In an embodiment of the present invention, during the meeting, the processor 104 may transmit to one or more players, e.g., the players' cell phones, messages identifying particular interests, goals, quirks, anecdotes, or events of or pertaining to other players. These may be transmitted in order to provide topics of conversation. The processor 104 may choose particular interests, characteristics, goals, etc. which the processor 104 determines is likely to lead the players to discover attributes of the other players in the group to which the players are likely to find attractive. For example, the processor 104 may make this determination by matching interests of a number of players. These conversation starters may be transmitted, e.g., intermittently throughout each round of the game.

Each round may be allotted a predetermined amount of time. After passage of the predetermined amount of time, the processor 104 may divide each group into two (or more) sub-groups. Just as the original groups may be determined by a likelihood of benefit, e.g., enjoyment of the players, the sub-groups may be similarly determined. In one embodiment, the processor 104 may transmit to each of the players a message requesting the players to submit a list of members with whom the player desires to be joined in the sub-group. In addition, or alternatively, the players may transmit to the server comments regarding other players in the group. The processor 104 may consider the submitted lists and/or the comments when determining the allocation of the players to the sub-groups.

During or after a round, one or more players may quit the game. If between rounds the processor 104 receives rejection messages for a subsequent round, or does not receive an acceptance message within a predetermined amount of time, the processor 104 may transmit to the remaining players messages indicating termination of the game. Alternatively, the processor 104 may invite new people to join the game or may combine remaining members of a plurality of groups, e.g., as long as a minimum number of groups can be formed.

For round two, the processor 104 may form new groups 5-8 by pairing sub-groups A-H of original groups 1-4, as illustrated in FIG. 3. For example, group 5 may be formed by combining sub-groups A and C. The processor 104 may transmit to each player of new groups 5-8 a message identifying a location at which to meet. Some players may be instructed to meet at the same location to which they were directed during round 1. Others may be directed to different locations.

In an embodiment of the present invention, for the first round, the formation of one or more of the groups may be entirely formed by a system member, but the processor 104 may proceed according to game rules that provide that any group that has participated in a round of the game must be divided for a subsequent round. According to this embodiment, for the subsequent round, formation of the groups is at least partially performed by the processor 104.

In one embodiment, new groups may be added from round to round. For example, while round 1 might include 2 player groups, round 2 may include 3 or more player groups.

The game may thus continue for a predetermined number of rounds, a predetermined amount of time, or until too few players remain. In one embodiment of the present invention, the processor 104 may proceed according to game rules that require that the sub-groups determined at the end of round 1 remain intact throughout the life of the game. Accordingly, while for a round 3 (not shown) sub-groups A and D may be paired up, the processor 104 may keep sub-groups A and D unchanged.

In an embodiment of the present invention, the processor 104 may store in a member's assigned memory location 110 a record of the other members with whom the member was grouped during a game. The system may provide for the user to associate comments with particular ones of the recorded members.

In an embodiment of the present invention, the system may provide for a public record of all the members that have joined games, including indications of the times of the games played, and the locations at which they were conducted. A member may accordingly access the public record to determine other members with whom the member nearly met. This may be of interest, for example, because it may indicate that it might be desirable to arrange a meeting with the member nearly met. According to this embodiment, a user may indicate a preference for keeping the member's meetings private, in which instance the processor 104 may omit reference to the meeting in the public record.

In an embodiment of the present invention, a user may be charged for participating in a game. A first user may pay for a second user to participate in the game. In one embodiment, the processor 104 may store in the memory 105 a record of each payment by one user for another user. In one embodiment, if a first person pays for a second person for a current game or for a previous game, and if a third person pays for a fourth person for the current game or for a previous game, the processor may transmit, during the current game, a message to the second and fourth people. The message to the second person may suggest buying a drink for the third person, and the message to the fourth person may suggest buying a drink for the first person. Accordingly, the processor 104 may keep track of a first group including all those who have performed a favor for others, and of a second group including of all those for whom favors have been performed. The messages transmitted during the game may, e.g., randomly, remap members of the first group to members of the second group. This may further encourage interaction between the players. Aside from payment for participation in a game, the processor 104 may similarly record any other favor indicated to the processor 104 by users.

In an embodiment of the present invention, a game moderator may be assigned to and may be stationed at each game location when game players are present at the game location. Alternatively, for each game round, a game moderator may be assigned to each player group to accompany the player group. In one embodiment, a particular game moderator is assigned. For example, regardless of the particular device used, a person may log into the system as the moderator by identifying the person as the moderator, e.g., by using a particular moderator assigned password. In an alternative embodiment, a particular device is assigned for game moderation regardless of who uses the device. It may occur that one or more players to not possess a mobile device that includes the capability of communicating with the processor 104. The game moderator may carry such a device having the capability of communicating with the processor 104. The processor 104 may permit the game moderator to act as a proxy for all or particularly identified players of the location or group assigned to the game proxy. With said permission, the game proxy may receive and/or transmit game related information on behalf of said players.

In an embodiment of the present invention, the processor 102 may designate a particular user as a master user or a particular device as a master device. The master user and/or device may be given permission to manually override some decisions by the processor 102. For example, the master user or the user operating the master device may determine that a particular location selected by the processor 102 should not be used or that a particular user should not be invited to a game. In one embodiment, users may communicate with the master user and/or master device requesting certain decisions to be overridden. The master user or user operating the master device may accordingly manually override the processor's decision and choose a different location and/or user.

In an embodiment of the present invention, the system may provide for continued communication between those who have met in person, e.g., via their phones or e-mail. Since the system arranges for a meeting between members who often have otherwise not had any previous contact, and therefore may be wary of each other for some time, the system may, e.g., for security reasons or for convenience of the members, provide for communication while protecting the members' contact information, e.g., until the members decide to disclose such information. For example, the system may provide to a first member a system address that corresponds to a particular second member. In response to a message transmitted by the first member to the system address, the system may in turn place a call to the phone of the second member, or may transmit an e-mail to the e-mail account of the second member. The second member's personal contact information may therefore be protected. In one embodiment, the second member may instruct the system to block all messages by the first member. In response to such instruction, the system may refrain from forwarding messages by the first member to the devices or accounts of the second member.

In one example embodiment, the system may provide for the second member to set up such system addresses for particular other members or users of the system. For example, the second member may set up a particular system address which may be for receiving messages from only the first member. Additionally, the system address may also be used by the second member for contacting the first member. In this way, the second member may transmit a message to the first member, while restricting the availability of the second member's contact information since the message is sent from the system address, rather than from the second member's device. In one example embodiment, the system may provide for setting up such a system address by a procedure in which the second member transmits a system-address-creating request to the system with a number indicating an amount of time the address is to remain activated, e.g., for 5 days. After passage of the indicated amount of time, the system may transmit to second member, i.e., the system address creator, a message requesting further instructions. Such instructions may be, e.g., to inform the first member of the second member's personal contact information, extend the amount of time, or block the first member. The system may follow the indicated instructions.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method for facilitating an assembly, comprising:
choosing by a processor a meeting location;
transmitting an identification of the meeting location to a plurality of user-assigned data transmission destinations.

2. The method of claim 1, further comprising:
receiving from one of the plurality of user-assigned data transmission destinations an assembly request, the choosing of the meeting location being performed in response to the request.

3. The method of claim 2, wherein the request includes an identification of at least one user, further comprising:
in response to the request, transmitting to a data transmission destination of the identified at least one user a meeting invitation.

4. The method of claim 3, further comprising:
transmitting to the plurality of user-assigned data transmission destinations an assembly-dissolution message upon non-satisfaction of a condition that an acceptance message is received from at least a predetermined number ‘n’ of users within a first predetermined time period;
one of (a) receiving from the data transmission destination of the identified at least one user one of the acceptance message and a rejection message, and (b) determining that the at least one user rejected the invitation if no response is received within a second predetermined time period;
choosing by the processor at least one additional user from a plurality of users at least if one of (a) less than ‘n’−1 users are identified in the request, and (b) the at least one user rejected the invitation; and
transmitting the meeting invitation to a data transmission destination of the at least one additional user.

5. The method of claim 4, wherein the assembly-dissolution message is transmitted upon non-satisfaction of a condition that a predetermined number of first user groups is formed within one of the first predetermined time period and a second predetermined time period, wherein each group includes at least ‘n’ users.

6. The method of claim 5, wherein the choosing of the at least one additional user is performed repeatedly until one of (a) the acceptance message is received from ‘n’ users×the predetermined number of groups and (b) the assembly-dissolution message is transmitted, and wherein the transmitting of the meeting invitation is performed for each chosen at least one additional user.

7. The method of claim 6, wherein the assembly is for implementing a game.

8. The method of claim 7, further comprising:
one of (a) in response to a group change request and (b) after a third predetermined time period:
dividing each of the groups into a plurality of sub-groups; and
combining sub-groups of different ones of the first user groups to form a plurality of second user groups; and
transmitting to the user-assigned data transmission destination of each user of the plurality of second user groups one of the identification of the meeting location and an identification of a new meeting location;
wherein all users of a single group receive a common meeting location identification; and
wherein group divisions and formations are repeatedly performed until the game is terminated.

9. The method of claim 8, wherein at least one characteristic of each of the plurality of users is considered for the choosing of the at least one additional user.

10. The method of claim 9, wherein the at least one characteristic includes at least one of gender, race, religion, ethnicity, an anecdote, a recorded event, a recorded activity, and preferences of users who have already joined the game.

11. The method of claim 8, further comprising:
for at least one of each meeting location identification, each user group, and each user sub-group, assigning one of a game moderator and a game moderator device with permission to act as a proxy for at least one of transmitting and receiving data on behalf of a player.

12. The method of claim 1, wherein the user-assigned data transmission destinations are one of user-assigned devices and user-assigned data storage locations.

13. The method of claim 1, wherein the identification of the meeting location is transmitted using one of Short Message Service (SMS), Multimedia Messaging Service (MMS), a Flash program, and a Java program.

14. The method of claim 1, further comprising:
calculating a rating value for each of a plurality of locations;
wherein a location for which a highest rating value is calculated is chosen as the meeting location, and wherein, for each of the plurality of locations, the calculation of the rating value is made in accordance with at least one of a rating of the location submitted by at least one of the users to whom the data-transmission destinations are assigned, a convenience to the at least one user, a comment posted by the at least one user, and a recorded comment associated with the location.

15. The method of claim 1, wherein the meeting location is a real space location.

16. The method of claim 1, further comprising:
during the assembly, transmitting to a user-assigned data transmission destination a message including information regarding a user who has joined the assembly.

17. A computer-readable medium having stored thereon instructions adapted to be executed by a processor, the instructions which, when executed, cause the processor to perform the method of claim 1.

18. A method for facilitating an assembly, comprising:
determining by a processor commonalities of a plurality of users;
calculating a rating for each of a plurality of real space locations;
determining for which of the locations a highest rating was calculated; and
in accordance with the determined commonalities, inviting the plurality of users to the determined location.

19. The method of claim 18, wherein, for each of the locations, the rating is calculated by considering at least one of a conduciveness of the location for the meeting, a user-assigned rating, geographic coordinates of the location, and a frequency of recorded visits to the location.

20. The method of claim 18, further comprising:
transmitting to at least one of the users a message indicating a way by which to identify other assembled users.

21. The method of claim 18, further comprising:
providing to a first one of the plurality of users a system address for contacting a second one of the plurality of users;
in response to a first data transmission transmitted to the system address, forwarding data of the first transmission to at least one of an e-mail account and a communications device of the second user.

22. The method of claim 21, wherein the data of the first transmission is forwarded to the at least one of the e-mail account and the communications device of the second user upon a condition that the data of the first transmission is received from at least one of an e-mail account and a communications device of the first user, further comprising:
in response to a second data transmission transmitted by the second user to the system address, forwarding data of the second transmission to at least one of the e-mail account and the communications device of the second user.

23. A computer network, comprising:
a plurality of user devices;
a memory; and
a processor configured to:
store in the memory data regarding a plurality of real space locations and regarding a plurality of users, wherein each of the plurality of user devices is assigned to a corresponding one of the plurality of users;
determine commonalities of a sub-plurality of the plurality of users;
calculate a rating for each of the real space locations;
determine for which of the locations a highest rating was calculated; and
transmit to each user device that corresponds to one of the sub-plurality of users an invitation to meet at the determined location.

24. A method, comprising:
receiving at a plurality of user-assigned data transmission destinations an identification of a meeting location chosen by a processor.

25. The method of claim 24, further comprising:
transmitting from one of the user-assigned data transmission destinations to the processor an assembly request for causing the choosing by the processor of the meeting location.

26. The method of claim 25, wherein the assembly request is transmitted for implementing a game.

27. The method of claim 24, wherein at least one of the plurality of user-assigned transmission destinations receives the identification of the meeting location because of a selection by the processor of at least one user-assigned transmission destination based on at least one characteristic of a user associated with the at least one user-assigned transmission destination.

28. The method of claim 24, wherein the meeting location is a real space meeting location.

29. A method, comprising:
transmitting data by each of a plurality of users to a processor, the data representing at least one characteristic of the user;
transmitting by at least one user data representing information regarding at least one location;
in accordance with commonalities of the plurality of users determined by the processor, receiving by the plurality of users from the processor an invitation to a location determined by the processor in accordance with the information regarding the at least one location.
